(19) United States
(12) Patent Application Publication
(10) Pub. No.: US 2024/0249339 A1
(43) Pub. Date: Jul. 25, 2024

(54) INFORMATION PROCESSING APPARATUS, INFORMATION PROCESSING METHOD, AND INFORMATION PROCESSING PROGRAM

(71) Applicant: ZOZO, Inc., Chiba (JP)

(72) Inventors: Takuya UEDA, Chiba (JP); Kengo ONO, Chiba (JP); Yasuhiro MORITA, Chiba (JP); Fuminori ANDO, Chiba (JP)

(21) Appl. No.: 18/566,059

(22) PCT Filed: Aug. 3, 2022
(86) PCT No.: PCT/IB2022/057197

§ 371 Date: Nov. 30, 2023

(30) Foreign Application Priority Data
Jun. 4, 2021 (JP) 2021-094806

(51) Int. Cl. G06Q 30/0601; G06Q 30/0273

(52) U.S. Cl. CPC G06Q 30/0631; G06Q 30/0275

(57) ABSTRACT

To promote improvement in services related to purchase of a replacement for a personal property based on a body shape change of a user. An information processing apparatus includes an acquisition unit, a determination unit, and a providing unit. The acquisition unit acquires information on a body shape of a user. The determination unit determines whether a change of the body shape is equal to or larger than a predetermined threshold based on the information on the body shape of the user acquired by the acquisition unit. The providing unit, when the determination unit determines that the change of the body shape is equal to or larger than the predetermined threshold, provides information for proposing purchase of a substitute of a personal property of the user, the personal property not fitting the body shape of the user due to the change.

### FIELD

The present invention relates to an information processing apparatus, an information processing method, and an information processing program.

### BACKGROUND

Conventionally, a technology for proposing a target object, such as clothes, to a user is known. For example, a technology for proposing a target object that fits a body shape of a user based on body information on the user is known.

### CITATION LIST

### Patent Literature

Japanese Laid-open Patent Publication No. 2020-144503

### SUMMARY

### Technical Problem

However, in the conventional technology, it is difficult to provide a proposal for purchase of a replacement in the form of a pair of a personal property that does not fit the body shape and a substitute that corresponds to the personal property, so that it is difficult to improve services related to purchase of a replacement for the personal property.

The present application has been conceived in view of the foregoing situation, and an object of the present application is to promote improvement in services related to purchase of a replacement for a personal property based on a body shape change of a user.

### Solution to Problem

According to the present disclosure, an information processing apparatus includes an acquisition unit that acquires information on a body shape of a user; a determination unit that determines whether a change of the body shape is equal to or larger than a predetermined threshold based on the information on the body shape of the user acquired by the acquisition unit; and a providing unit that, when the determination unit determines that the change of the body shape is equal to or larger than the predetermined threshold, provides information for proposing purchase of a substitute of a personal property of the user, the personal property not fitting the body shape of the user due to the change.

### Advantageous Effects of Invention

According to one aspect of embodiments, it is possible to promote improvement in services related to purchase of a replacement for a personal property based on a body shape change of a user.

### BRIEF DESCRIPTION OF DRAWINGS

FIG. 1 is a diagram illustrating a configuration example of an information processing system according to one embodiment.

FIG. 2 is a diagram illustrating an example of information processing according to one embodiment.

FIG. 3 is a diagram illustrating a configuration example of a terminal apparatus according to one embodiment.

FIG. 4 is a diagram illustrating a configuration example of an information processing apparatus according to one embodiment.

FIG. 5 is a diagram illustrating an example of a personal property information storage unit according to one embodiment.

FIG. 6 is a diagram illustrating an example of a user attribute storage unit according to one embodiment.

FIG. 7 is a diagram illustrating an example of a measurement history storage unit according to one embodiment.

FIG. 8 is a diagram illustrating a configuration example of a management server according to one embodiment.

FIG. 9 is a diagram illustrating an example of a purchase history storage unit according to one embodiment.

FIG. 10 is a diagram illustrating an example of a product information storage unit according to one embodiment.

FIG. 11 is a flowchart illustrating an example of information processing according to one embodiment.

FIG. 12 is a diagram illustrating an example of information processing according to a modification.

FIG. 13 is a hardware configuration diagram illustrating an example of a computer that implements functions of the information processing apparatus.

### DESCRIPTION OF EMBODIMENTS

Modes (hereinafter, referred to as “embodiments”) for carrying out an information processing apparatus, an information processing method, and an information processing program according to the present application will be described in detail below with reference to the drawings. The information processing apparatus, the information processing method, and the information processing program according to the present application are not limited by the embodiments below. In addition, in each of the embodiments below, the same components are denoted by the same reference symbols, and repeated explanation will be omitted.

### Embodiment

### 1. Configuration of Information Processing System

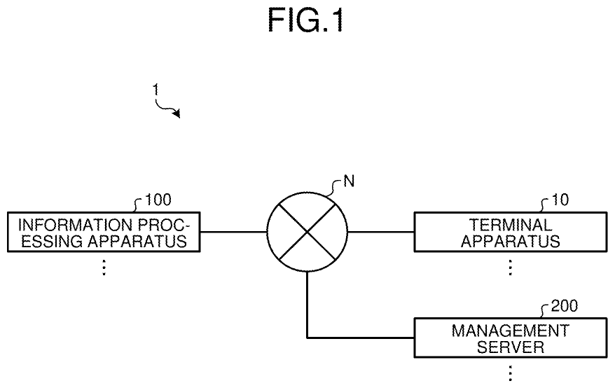

An information processing system 1 illustrated in FIG. 1 will be described. As illustrated in FIG. 1, the information processing system 1 includes a terminal apparatus 10, an information processing apparatus 100, and a management server 200. The terminal apparatus 10, the information processing apparatus 100, and the management server 200 are communicably connected to one another via a predetermined communication network (a network N) in a wired or wireless manner. FIG. 1 is a diagram illustrating a configuration example of the information processing system 1 according to one embodiment. Meanwhile, the information processing system 1 illustrated in FIG. 1 may include the plurality of terminal apparatuses 10, the plurality of information processing apparatuses 100, and the plurality of management servers 200.

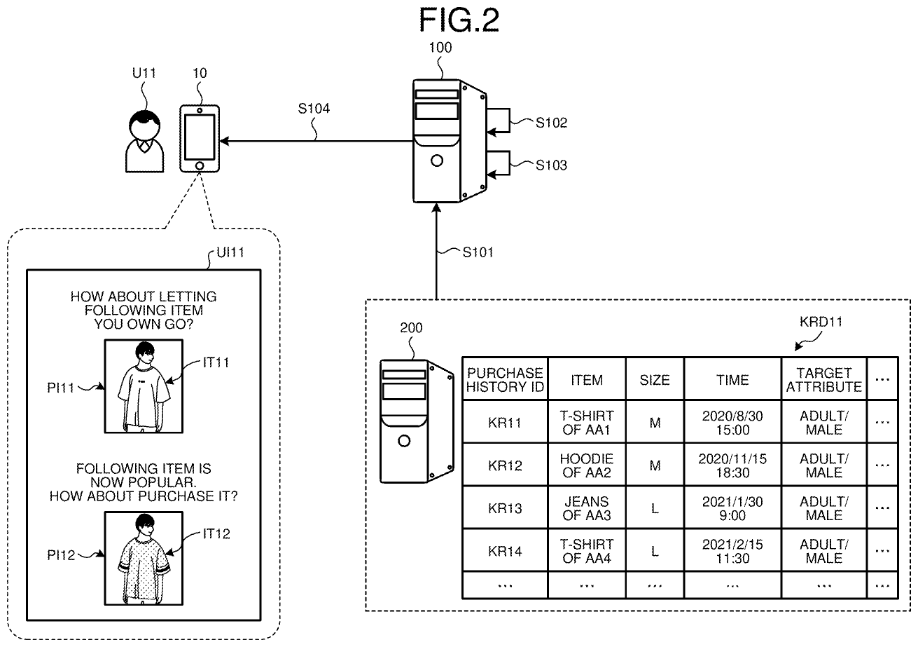

The terminal apparatus 10 is an information processing apparatus that is used by a user. The terminal apparatus 10 may be any apparatus as long as it is possible to implement processes of embodiments. Further, the terminal apparatus 10 may be any apparatus, such as a smartphone, a tablet terminal, a notebook personal computer (PC), a desktop PC, a mobile phone, or a portable digital assistant (PDA). In an example illustrated in FIG. 2, a case is illustrated in which the terminal apparatus 10 is a smartphone.

The terminal apparatus 10 is, for example, a smart device, such as a smartphone or a tablet, and is a mobile terminal apparatus that is able to perform communication with an arbitrary server apparatus via a wireless communication network, such as 3rd Generation (3G) or a Long Term Evolution (LTE). Further, the terminal apparatus 10 may include a screen, such as a liquid crystal display, with a function of a touch panel, and may receive various kinds of operation, such as tap operation, sliding operation, or scroll operation, on display data, such as contents, from a user by a finger, a stylus, or the like. In the example illustrated in FIG. 2, the terminal apparatus 10 is used by a user U11. In the following, the terminal apparatus 10 may be described as the user U11. In other words, in the following, the user U11 may be read as the terminal apparatus 10.

The information processing apparatus 100 is an information processing apparatus for achieving improvement in services related to purchase of a replacement, and is implemented by, for example, a server apparatus, a cloud system, or the like. For example, the information processing apparatus 100 has a function to provide information for proposing letting go of a personal property that does not fit a body shape of a user and proposing purchase of a replacement based on information on the body shape of the user. The information processing apparatus 100 is, for example, an information processing apparatus, such as a PC or a workstation (WS), and performs processes based on information that is transmitted from the management server 200 or the like via the network N.

The management server 200 is an information processing apparatus that manages an electronic mall, and is implemented by, for example, a server apparatus, a cloud system, or the like. For example, the management server 200 has a function to provide information (for example, an item or a size of a purchased product) on a purchase history of the user in the electronic mall. The management server 200 is, for example, an information processing apparatus, such as a PC or a WS, and performs processes based on information that is transmitted from the terminal apparatus 10 or the like via the network N.

Meanwhile, FIG. 1 illustrates a case in which the terminal apparatus 10, the information processing apparatus 100, and the management server 200 are separate apparatuses, but the terminal apparatus 10, the information processing apparatus 100, and the management server 200 may be integrated with one another. Further, arbitrary two of the terminal apparatus 10, the information processing apparatus 100, and the management server 200 may be integrated with each other.

### 2. One Example of Information Processing

In recent years, a demand for services for selling items that are purchased from users as second-hand products is more and more increasing. Further, a demand for accepting trade-in of an item that a user has purchased in the past in the electronic mall and allowing the user to purchase at a discount price at the time of placing a new order is more and more increasing. For example, a demand for a service called replacement discount is more and more increasing.

In the embodiment described below, for convenience of explanation, an example will be described in which clothes are adopted as an example of a personal property of a user, but embodiments are not limited to this example. The personal property is not limited to the clothes, but includes any object as long as the object is wearable by the user and a fit size of the object differs depending on the body shape of the user. For example, jewelry, such as a ring, may be adopted. Further, in the embodiment below, an example will be described in which a single registered account is associated with a single user in a predetermined electronic mall that is managed by the management server 200, but embodiments are not limited to this example. Meanwhile, a process in which a plurality of users are associated with a single registered account will be described later as a modification.

FIG. 2 is a diagram illustrating an example of information processing performed by the information processing system 1 according to one embodiment. In FIG. 2, it is assumed that a proposal is given to the user U11 via the terminal apparatus 10.

The information processing apparatus 100 acquires information on a body shape of the user U11 (Step S101). Meanwhile, the information processing apparatus 100 may acquire the information on the body shape of the user U11 by any method. FIG. 2 illustrates a case in which the information processing apparatus 100 acquires the information on the body shape of the user U11 from the management server 200, but embodiments are not limited to this example.

The information processing apparatus 100 may acquire, as the information on the body shape of the user U11, information on a body shape change that is estimated based on predetermined information, such as a purchase history, for example. In FIG. 2, the information processing apparatus 100 acquires purchase history information KRD11 that is information on a purchase history about a purchase that is performed by the user U11 in the predetermined electronic mall. Here, the example is illustrated in which an item of a purchased product identified by a purchase history ID of “KR11” is a “T-shirt of AA1”, a size is “M”, a purchase time is “Aug. 30, 2020 at 15:00”, and a target user attribute is “adult male”.

The information processing apparatus 100 estimates a body shape change of the user U11 from a change of the size of the purchased product based on the purchase history information KRD11, and acquires information on the estimated body shape change. In FIG. 2, the size of the purchased product of the user U11 is changed from “M” to “L”, and therefore, the information processing apparatus 100 estimates that the body shape of the user U11 is increased in accordance with the change of the size from “M” to “L”. Further, the information processing apparatus 100 acquires information on the body shape change based on the change of the size from “M” to “L” with respect to the purchased product.

The information processing apparatus 100 determines whether the change of the body shape is equal to or larger than a predetermined threshold based on the information on the body shape of the user U11 (Step S102). For example, the information processing apparatus 100 determines whether the change of the body shape is equal to or larger than the predetermined threshold by comparison with information on a past body shape. In FIG. 2, the information processing apparatus 100 determines whether the change of the body shape is equal to or larger than the predetermined threshold based on information on the change of the size of the purchased product. For example, the information processing apparatus 100 may determine that the change is smaller than the predetermined threshold when the size is changed from “M” to “L” and may determine that the change is equal to or larger than the predetermined threshold when the size is changed from “M” to “XL”. In FIG. 2, subsequent processes are explained based on the assumption that the information processing apparatus 100 determines that the change is equal to or larger than the predetermined threshold.

If it is determined that the change of the body shape is equal to or larger than the predetermined threshold, the information processing apparatus 100 identifies a personal property of the user U11 that is estimated as not fitting the body shape of the user U11 due to the change (Step S103). For example, the information processing apparatus 100 acquires the purchase history of the user U11 by accessing the management server 200, and identifies a personal property that is a purchased product that the user U11 has purchased in the electronic mall. Specifically, information on an item and a size of the personal property is identified. Further, the information processing apparatus 100 identifies the personal property of the user U11 that is estimated as not fitting the body shape of the user U11 based on comparison between the information on the size of the identified personal property and the information on the body shape of the user U11. Meanwhile, the information processing apparatus 100 may identify the personal property of the user U11 that is estimated as not fitting the body shape of the user U11 based on comparison with information on a body shape of the user U11 at the time of the purchase of the personal property as the information on the size of the identified personal property.

The information processing apparatus 100 transmits, to the terminal apparatus 10, information for proposing letting go of the personal property of the user U11 that is estimated as not fitting the body shape of the user U11 due to the body shape change (Step S104). Specifically, the information processing apparatus 100 provides information for proposing letting go of the personal property that does not fit the body shape and proposing purchase of a replacement. With this configuration, the information processing apparatus 100 is able to provide, as a pair, a proposal for letting go and a proposal for purchase of a replacement, so that it is possible to promote improvement in services related to purchase of a replacement for a personal property based on the body shape change of the user. Further, by proposing purchase of an item that is available for purchase in an electronic mall in which the personal property for which the proposal for letting go is given has been purchased, the information processing apparatus 100 is able to promote improvement in services related to purchase of a replacement because a purchase place of the personal property to be let go and a proposed purchase place of the replacement are the same place, that is, the same electronic mall.

A screen UI11 is one example of a UI screen for proposing letting go of a personal property that does not fit the body shape and proposing purchase of a replacement. The screen UI11 is displayed based on information that is provided by the information processing apparatus 100. The screen UI11 includes images PI11 and PI12. The image PI11 is an image of an item IT11 that is a personal property of the user U11 for which letting go is proposed. The item IT11 is a purchased product corresponding to an item of “T-shirt of AA1” included in the purchase history information KRD11, for example. The image PI11 is an item that is provided by the management server 200 that manages the predetermined electronic mall in which the user U11 has purchased the item IT11, for example.

The image PI12 is, for example, an image of an item IT12 which is a substitute for the item IT11 and for which purchase is proposed. The item IT12 is an item that is available for purchase in the predetermined electronic mall in which the item IT11 has been purchased, for example. The image PI12 is, for example, an image that is provided by the management server 200. Meanwhile, it is assumed that if the user U11 purchases the item IT12, the item IT 12 is added as a purchase history in the purchase history information KRD11. In this manner, the information processing apparatus 100 is able to manage information on the personal property and the body shape change of the user, so that it is possible to appropriately estimate the possibility of letting go of the personal property based on the body shape change of the user and give a proposal.

A substitute related to purchase of a replacement proposed by the information processing apparatus 100 will be described below. The information processing apparatus 100 proposes a purchase of an item that fits the current body shape as a substitute corresponding to the personal property that does not fit the body shape. For example, the information processing apparatus 100 may propose a purchase of an item that is the same as an item of the personal property not fitting the body shape and that has a certain size fitting the current body shape. Further, for example, the information processing apparatus 100 may propose a purchase of an item which fits the current body shape and which is popular, which is in fashion, or for which stock quantity is large in the predetermined electronic mall managed by the management server 200. Furthermore, for example, the information processing apparatus 100 may propose an optimal item at an optimal timing from both perspectives of letting go and a purchase of a replacement by taking into account stock information in the predetermined electronic mall or information on seasons. Moreover, for example, the information processing apparatus 100 may propose an optimal item by taking into account a degree of match of coordination with a personal property other than the personal property for which a proposal of letting go is to be given. Furthermore, for example, the information processing apparatus 100 may propose an optimal item by taking into account hobbies and preferences of the user.

Meanwhile, in the embodiment as described above, the case has been described in which the information processing apparatus 100 estimates the body shape change of the user based on the purchase history, but embodiments are not limited to this example. For example, the information processing apparatus 100 may estimate the body shape change of the user based on a user attribute. For example, in case of a child, it is expected that a body shape changes with age and it is possible to assume a body shape change in accordance with the age. For example, it is possible to assume that sizes of a height and a foot may change. The information processing apparatus 100 may estimate the information on the body shape of the user based on the user attribute, such as an age, gender, or a height, and make a proposal suitable for the current body shape of the user. For example, the information processing apparatus 100 may propose letting go of children's clothes that do not fit the body shape due to increase in age.

Meanwhile, in the embodiment as described above, the case has been described in which the information processing apparatus 100 estimates the body shape change of the user, but it may be possible to acquire the information on the body shape of the user based on an actual measurement history. For example, in recent years, a body shape measurement means that is able to measure a body shape of a user by being worn by the user is becoming popular. The information processing apparatus 100 may acquire the information on the body shape of the user based on a measurement history of measurement that is performed via the body shape measurement means that is able to measure the body shape of the user. Meanwhile, the body shape measurement means is not limited to means that is able to perform measurement by being worn by the user, but any means is applicable.

Meanwhile, in the embodiment as described above, the information processing apparatus 100 may regularly acquire the information on the purchase history of the user U11 and determine the body shape change or may irregularly acquire the information on the purchase history of the user U11 and determine the body shape change. Meanwhile, if the operation is performed regularly, for example, it may be possible to perform the operation based on a certain period that is determined in advance, such as every month, every half year, or every year. Further, if the operation is performed irregularly, for example, the operation may be performed by adopting a purchase in the predetermined electronic mall managed by the management server 200 as a trigger.

Meanwhile, in the embodiment as described above, the information processing apparatus 100 may propose exchange to electronic points that are given by letting go the personal property, as a proposal for letting go, for example. For example, the information processing apparatus 100 may perform a process of giving electronic points by putting up a target personal property for sale in the predetermined electronic mall that is managed by the management server 200. With this configuration, the information processing apparatus 100 is able to appropriately give points in exchange for putting up for sale in the predetermined electronic mall. Further, as another example, the information processing apparatus 100 may propose putting up for auctions, for example. Meanwhile, exchange to points and putting up for auctions are examples, and embodiments are not specifically limited.

Meanwhile, in the embodiment as described above, the information processing apparatus 100 may determine whether the personal property is repairable based on the information on the body shape of the user, and propose a repair if the personal property is repairable. Further, determination on whether the personal property is repairable may be performed based on any information as long as the information on the body shape of the user is used. For example, the information processing apparatus 100 may determine whether the personal property is repairable by comparing the information on the current body shape of the user and information on the size of the personal property. Furthermore, for example, the information processing apparatus 100 may determine whether the personal property is repairable by comparing the information on the current body shape of the user and the information on the body shape of the user at the time of purchase of the personal property. Meanwhile, the information processing apparatus 100 may perform a process of proposing letting go of the personal property if it is determined that the personal property is not repairable based on a determination result about whether the personal property is repairable.

### 3. Configuration of Terminal Apparatus

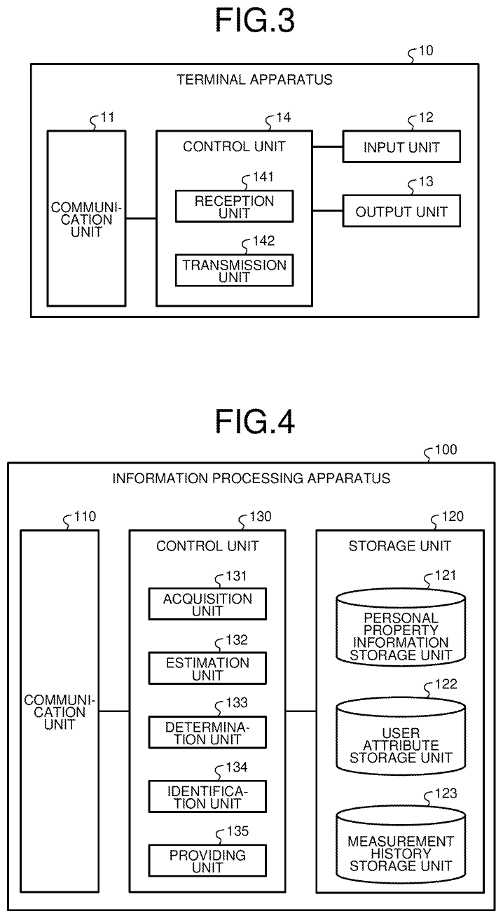

A configuration of the terminal apparatus 10 according to one embodiment will be described below with reference to FIG. 3. FIG. 3 is a diagram illustrating a configuration example of the terminal apparatus 10 according to one embodiment. As illustrated in FIG. 3, the terminal apparatus 10 includes a communication unit 11, an input unit 12, an output unit 13, and a control unit 14.

### Communication Unit 11

The communication unit 11 is implemented by, for example, a Network Interface Card (NIC) or the like. Further, the communication unit 11 is connected to the predetermined network N in a wired or wireless manner, and transmits and receives information to and from the information processing apparatus 100 or the like via the predetermined network N.

### Input Unit 12

The input unit 12 receives various kinds of operation from a user. In the example illustrated in FIG. 2, various kinds of operation from the user U11 are received. For example, the input unit 12 may receive various kinds of operation from the user via a display screen by a touch-panel function. Further, the input unit 12 may receive various kinds of operation from a button that is arranged in the terminal apparatus 10 or a keyboard or a mouse that is connected to the terminal apparatus 10.

### Output Unit 13

The output unit 13 is a display screen of a tablet terminal or the like that is implemented by, for example, a liquid crystal display, an organic Electro-Luminescence (EL) display, or the like, and is a display apparatus for displaying various kinds of information. For example, the output unit 13 displays information that is transmitted from the information processing apparatus 100.

### Control Unit 14

The control unit 14 is, for example, a controller, and is implemented by causing a Central Processing Unit (CPU), a Micro Processing Unit (MPU), or the like to execute various kinds of programs that are stored in an internal storage apparatus of the terminal apparatus 10 while using a Random Access Memory (RAM) as a work area. For example, the various kinds of programs include a program of an application that is installed in the terminal apparatus 10. For example, the various kinds of programs include a program of an application that displays information transmitted from the information processing apparatus 100. Further, the control unit 14 is implemented by, for example, an integrated circuit, such as an Application Specific Integrated Circuit (ASIC) or a Field Programmable Gate Array (FPGA).

As illustrated in FIG. 3, the control unit 14 includes a reception unit 141 and a transmission unit 142, and implements or executes operation of information processing as described below.

### Reception Unit 141

The reception unit 141 receives various kinds of information. The reception unit 141 receives various kinds of information from an external information processing apparatus. The reception unit 141 receives various kinds of information from a different information processing apparatus, such as the information processing apparatus 100. For example, the receiving unit 141 receives information for proposing letting go of a personal property that does not fit the body shape of the user and proposing purchase of a replacement.

### Transmission Unit 142

The transmission unit 142 transmits various kinds of information to an external information processing apparatus. The transmission unit 142 transmits various kinds of information to a different information processing apparatus, such as the information processing apparatus 100. For example, the transmitting unit 142 transmits information on the user attribute or the like that is input by the user.

### 4. Configuration of Information Processing Apparatus

A configuration of the information processing apparatus 100 according to one embodiment will be described below with reference to FIG. 4. FIG. 4 is a diagram illustrating a configuration example of the information processing apparatus 100 according to one embodiment. As illustrated in FIG. 4, the information processing apparatus 100 includes a communication unit 110, a storage unit 120, and a control unit 130. Meanwhile, the information processing apparatus 100 may include an input unit (for example, a keyboard, a mouse, or the like) that receives various kinds of operation from an administrator of the information processing apparatus 100, or a display unit (for example, a liquid crystal display or the like) for displaying various kinds of information.

### Communication Unit 110

The communication unit 110 is implemented by, for example, a NIC or the like. Further, the communication unit 110 is connected to the network N in a wired or wireless manner, and transmits and receives information to and from the terminal apparatus 10 or the like via the network N.

### Storage Unit 120

The storage unit 120 is implemented by, for example, a semiconductor memory device, such as a RAM or a flash memory, or a storage device, such as a hard disk or an optical disk. As illustrated in FIG. 4, the storage unit 120 includes a personal property information storage unit 121, a user attribute storage unit 122, and a measurement history storage unit 123.

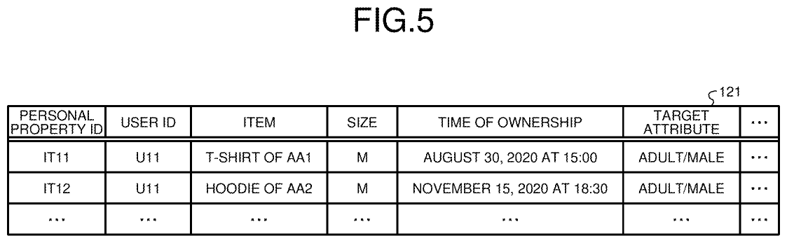

The personal property information storage unit 121 stores therein information on a personal property of a user. For example, the personal property information storage unit 121 stores therein information on a personal property that is estimated as being owned by the user based on the purchase history or information on a personal property that is registered in advance by the user. Here, FIG. 5 illustrates an example of the personal property information storage unit 121 according to one embodiment. As illustrated in FIG. 5, the personal property information storage unit 121 includes items, such as a “personal property ID”, a “user ID”, an “item”, a “size”, a “time of ownership”, and a “target attribute”.

The “personal property ID” indicates identification information for identifying a personal property. The “user ID” indicates identification information for identifying a user. The “item” indicates an item of the personal property. The “size” indicates a size of the personal property. The “time of ownership” indicates a time at which the user purchased the personal property or a time at which the user inputs information indicating that the user owns the personal property. The “target attribute” indicates an attribute of a target user of the personal property.

Specifically, FIG. 5 illustrates an example in which a user who owns a personal property that is identified by a personal property ID of “IT11” is identified by “U11”, an item of the personal property is a “T-shirt of AA1”, a size is “M”, a purchase time is “Aug. 30, 2020 at 15:00”, and a target attribute is “adult male”.

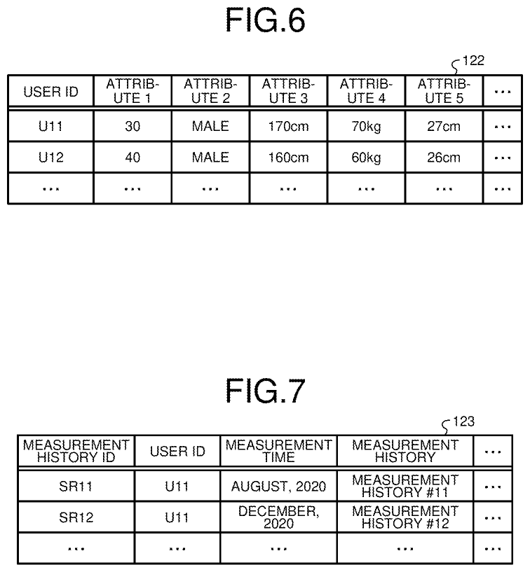

The user attribute storage unit 122 stores therein information on a user attribute. Here, FIG. 6 illustrates an example of the user attribute storage unit 122 according to one embodiment. As illustrated in FIG. 6, the user attribute storage unit 122 includes items, such as a “user ID”, an “attribute 1”, an “attribute 2”, an “attribute 3”, an “attribute 4”, and an “attribute 5”.

The “user ID” indicates identification information for identifying a user. The “attribute 1” indicates an age. The “attribute 2” indicates gender. The “attribute 3” indicates a height. The “attribute 4” indicates a weight. The “attribute 5” indicates a foot size.

Specifically, FIG. 6 illustrates an example in which an age of the user who is identified by the user ID of “U11” is “30”, gender is “male”, a height is “170 centimeters (cm)”, a weight is “70 kilograms (kg)”, and a foot size is “27 cm”.

The measurement history storage unit 123 stores therein information on a measurement history about actual measurement of the body shape of the user. Here, FIG. 7 illustrates an example of the measurement history storage unit 123 according to one embodiment. As illustrated in FIG. 7, the measurement history storage unit 123 includes items, such as a “measurement history ID”, a “user ID”, a “measurement time”, and a “measurement history”.

The “measurement history ID” indicates identification information for identifying a measurement history. The “user ID” indicates identification information for identifying a user. The “measurement time” indicates a measurement time. The “measurement history” indicates information on a measurement history. In the example illustrated in FIG. 7, an example is illustrated in which conceptual information, such as “measurement history #11” or “measurement history #12”, is stored in “the measurement history”, but in reality, information (for example, a measurement value) on a body shape, such as a shoulder width, is stored.

Specifically, FIG. 7 illustrates an example in which a user ID of a user who has been subjected to measurement identified by a measurement history ID of “SR11” is identified by “U11”, the measurement time is “August, 2020”, and the measurement history is the “measurement history #11”.

### Control Unit 130

The control unit 130 is a controller and is implemented by, for example, causing a CPU, an MPU, or the like to execute various kinds of programs that are stored in an internal storage apparatus of the information processing apparatus 100 while using a RAM as a work area. Further, the control unit 130 is a controller and is implemented by, for example, an integrated circuit, such as an ASIC or an FPGA.

As illustrated in FIG. 4, the control unit 130 includes an acquisition unit 131, an estimation unit 132, a determination unit 133, an identification unit 134, and an providing unit 135, and implements or executes operation of information processing as described below. Meanwhile, an internal configuration of the control unit 130 is not limited to the configuration as illustrated in FIG. 4, and any configuration is applicable as long as the information processing to be described later is performed.

### Acquisition Unit 131

The acquisition unit 131 acquires various kinds of information. The acquisition unit 131 acquires various kinds of information from an external information processing apparatus. The acquisition unit 131 acquires various kinds of information from a different information processing apparatus, such as the management server 200.

The acquisition unit 131 acquires various kinds of information from the storage unit 120. The acquisition unit 131 acquires various kinds of information from the personal property information storage unit 121, the user attribute storage unit 122, or the measurement history storage unit 123. Further, the acquisition unit 131 stores various kinds of acquired information in the storage unit 120. The acquisition unit 131 stores various kinds of information in the personal property information storage unit 121, the user attribute storage unit 122, or the measurement history storage unit 123.

The acquisition unit 131 acquires information on the body shape of the user. For example, the acquisition unit 131 acquires information on a measurement history about actual measurement via a body shape measurement means. Further, the acquisition unit 131 acquires the information on the body shape of the user based on the measurement history. Furthermore, for example, the acquisition unit 131 acquires information on a purchase history about a purchase that is performed in the predetermined electronic mall. Moreover, the acquisition unit 131 acquires the information on the body shape of the user that is estimated based on the purchase history. Furthermore, for example, the acquisition unit 131 acquires information on the user attribute, such as an age, gender, or a height. Moreover, the acquisition unit 131 acquires the information on the body shape of the user that is estimated based on the user attribute.

The acquisition unit 131, when a plurality of users are associated with a single account, acquires the information on the body shape of the user for each of the users.

### Estimation Unit 132

The estimation unit 132 estimates the information on the body shape of the user based on the information that is acquired by the acquisition unit 131. Specifically, the estimation unit 132 estimates a body shape change of the user. For example, the estimation unit 132 estimates the body shape change of the user based on a change of the size of the purchased product included in the purchase history of the user. Further, for example, the estimation unit 132 estimates the body shape change according to an age in consideration of a change of the body shape with age, based on the user attribute.

The estimation unit 132, when a plurality of users are associated with a single account, may estimate the user attribute for each of the users. Further, the estimation unit 132 may estimate a relationship, such as a family structure, of the plurality of users based on the estimation result.

### Determination Unit 133

The determination unit 133 determines whether the change of the body shape is equal to or larger than a predetermined threshold based on the information on the body shape of the user acquired by the acquisition unit 131. For example, the determination unit 133 determines whether the change of the body shape is equal to or larger than the predetermined threshold based on the body shape change that is estimated by the estimation unit 132. As a specific example, if the size of the purchased product included in the purchase history is increased by two ranks (for example, M size to XL size or S size to L size), the determination unit 133 determines that the change of the body shape is equal to or larger than the predetermined threshold.

The determination unit 133 may determine whether the personal property fits the body shape of the user based on comparison between the information on the body shape of the user and the information on the size of the personal property. Further, the determination unit 133 may determine whether the personal property fits the current body shape of the user based on comparison with information on a body shape at the time of purchase of the personal property.

The determination unit 133 may determine whether the personal property is repairable based on comparison between the information on the body shape of the user and the information on the size of the personal property. Further, the determination unit 133 may determine whether the personal property is repairable based on comparison between information on the current body shape of the user and the information on the body shape of the user at the time of purchase of the personal property. Meanwhile, when determining that the personal property is repairable, the determination unit 133 may determine that the personal property will fit the current body shape of the user by repair and give a notice of a proposal for repair.

The determination unit 133 may determine whether a plurality of users are associated with a single account. Further, when a plurality of users are associated with a single account, the determination unit 133 may determine a body shape change for each of the users.

### Identification Unit 134

The identification unit 134, when the determination unit 133 determines that the change of the body shape is equal to or larger than the predetermined threshold, identifies a personal property that does not fit the body shape of the user. Specifically, the identification unit 134 identifies the personal property that is determined as not fitting the body shape of the user by the determination unit 133. For example, the identification unit 134 identifies the personal property that is determined as not fitting the body shape of the user based on the estimation result obtained by the estimation unit 132.

The identification unit 134 identifies a substitute corresponding to the personal property that does not fit the body shape of the user. Specifically, the identification unit 134 identifies, in a predetermined electronic mall in which the personal property has been purchased, a substitute that is available for purchase in the predetermined electronic mall.

### Providing Unit 135

The providing unit 135 provides (transmits) information for proposing letting go of the personal property identified by the identification unit 134 and proposing purchase of a replacement. Specifically, the providing unit 135 provides information for proposing purchase of a substitute that is available for purchase in the predetermined electronic mall in which the personal property has been purchased.

### 5. Configuration of Management Server

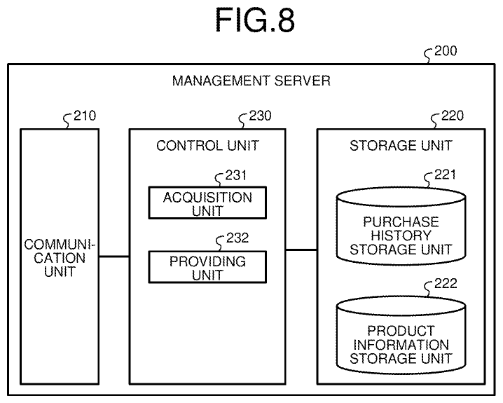

A configuration of the management server 200 according to one embodiment will be described below with reference to FIG. 8. FIG. 8 is a diagram illustrating a configuration example of the management server 200 according to one embodiment. As illustrated in FIG. 8, the management server 200 includes a communication unit 210, a storage unit 220, and a control unit 230. Meanwhile, the management server 200 may include an input unit (for example, a keyboard, a mouse, or the like) that receives various kinds of operation from an administrator of the management server 200, or a display unit (for example, a liquid crystal display or the like) for displaying various kinds of information.

### Communication Unit 210

The communication unit 210 is implemented by, for example, a NIC or the like. Further, the communication unit 210 is connected to the network N in a wired or wireless manner, and transmits and receives information to and from the information processing apparatus 100 or the like via the network N.

### Storage Unit 220

The storage unit 220 is implemented by, for example, a semiconductor memory device, such as a RAM or a flash memory, or a storage device, such as a hard disk or an optical disk. As illustrated in FIG. 8, the storage unit 120 includes a purchase history storage unit 221 and a product information storage unit 222.

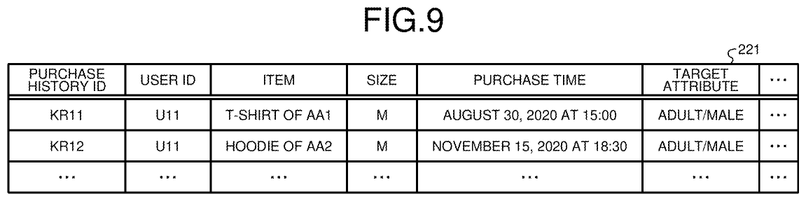

The purchase history storage unit 221 stores therein information on the purchase history of the user. For example, the purchase history storage unit 221 stores therein information on a purchase history about a purchase performed in the predetermined electronic mall that is managed by the management server 200. Here, FIG. 9 illustrates an example of the purchase history storage unit 221 according to one embodiment. As illustrated in FIG. 9, the purchase history storage unit 221 includes items, such as a “purchase history ID”, a “user ID”, an “item”, a “size”, a “purchase time”, and a “target attribute”.

The “purchase history ID” indicates identification information for identifying a purchase history. The “user ID” indicates identification information for identifying a user. The “item” indicates an item of a purchased product. The “size” indicates a size of the purchased product. The “purchase time” indicates a time when the purchased product is purchased. The “target attribute” indicates an attribute of a target user of the purchased product.

Specifically, FIG. 9 illustrates an example in which a user who has performed a purchase that is identified by a purchase history ID of “KR11” is identified by “U11”, an item of the purchased product is a “T-shirt of AA1”, a size is “M”, a purchase time is “Aug. 30, 2020 at 15:00”, and a target attribute is “adult male”.

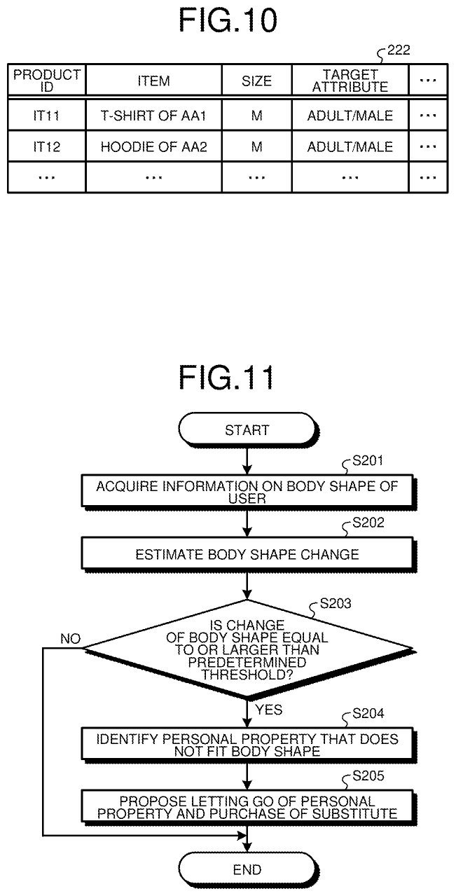

The product information storage unit 222 stores therein product information. For example, the product information storage unit 222 stores therein information on a product that is available for purchase in the predetermined electronic mall that is managed by the management server 200. Here, FIG. 10 illustrates an example of the product information storage unit 222 according to one embodiment. As illustrated in FIG. 10, the product information storage unit 222 includes items, such as a “product ID”, an “item”, a “size”, and a “target attribute”.

The “product ID” is identification information for identifying a product. The “item” indicates an item of the product. The “size” indicates a size of the product. The “target attribute” indicates an attribute of a target user of the product.

Specifically, FIG. 10 illustrates an example in which an item of a product that is identified by a product ID of “IT11” is a “T-shirt of AA1”, a size is “M”, and a target attribute is “adult male”.

### Control Unit 230

The control unit 230 is a controller and is implemented by, for example, causing a CPU, an MPU, or the like to execute various kinds of programs that are stored in an internal storage apparatus of the management server 200 while using a RAM as a work area. Further, the control unit 230 is a controller and is implemented by, for example, an integrated circuit, such as an ASIC or an FPGA.

As illustrated in FIG. 8, the control unit 230 includes an acquisition unit 231 and a providing unit 232, and implements or executes operation of information processing as described below. Meanwhile, an internal configuration of the control unit 230 is not limited to the configuration as illustrated in FIG. 8, and any configuration is applicable as long as the information processing to be described later is performed.

### Acquisition Unit 231

The acquisition unit 231 acquires information on a purchase that is performed by the user in the predetermined electronic mall that is managed by the management server 200. For example, when the user performs a purchase, the acquisition unit 231 acquires information on a purchased product.

The acquisition unit 231, when the management server 200 stores the user attribute storage unit 122 and the measurement history storage unit 123 in the storage unit 220, may acquire the information on the user attribute and the information on the measurement history.

### Providing Unit 232

The providing unit 232 provides the information on the purchase history of the user. Meanwhile, the providing unit 232, when the management server 200 stores the user attribute storage unit 122 and the measurement history storage unit 123 in the storage unit 220, may provide the information on the user attribute and the information on the measurement history.

### 6. Flow of Information Processing

The flow of information processing performed by the information processing system 1 according to one embodiment will be described below with reference to FIG. 11. FIG. 11 is a flowchart illustrating the flow of the information processing performed by the information processing system 1 according to one embodiment.

As illustrated in FIG. 11, the information processing apparatus 100 acquires the information on the body shape of the user (Step S201).

The information processing apparatus 100 estimates a body shape change based on the acquired information on the body shape of the user (Step S202).

The information processing apparatus 100 determines whether the change of the body shape is equal to or larger than the predetermined threshold based on the estimated body shape change (Step S203).

If it is determined that the change of the body shape is equal to or larger than the predetermined threshold (Step S203; YES), the information processing apparatus 100 identifies a personal property of the user that is estimated as not fitting the body shape (Step S204).

The information processing apparatus 100 provides information for proposing letting go of the identified personal property and proposing purchase of a substitute (Step S205).

In contrast, if it is determined that the change of the body shape is not equal to or larger than the predetermined threshold (Step S203; NO), the information processing apparatus 100 terminates the information processing.

### 7. Modification

The information processing system 1 according to one embodiment as described above may be embodied in various different forms other than the embodiment as described above. Therefore, other embodiments of the information processing system 1 will be described below.

Case in which plurality of users are associated with single account

In the embodiment as described above, the example has been explained in which a single user is associated with a single registered account in the predetermined electronic mall that is managed by the management server 200, but embodiments are not limited to this example. Specifically, in the embodiment as described above, a plurality of users may be associated with a single registered account. For example, when the user has a family, there may be a case in which the user purchases a product for the family (for example, a child of the user or the like). A process that is performed when a plurality of users are associated with a single registered account in the predetermined electronic mall that is managed by the management server 200 will be described below. Meanwhile, the same explanation as FIG. 2 will be appropriately omitted.

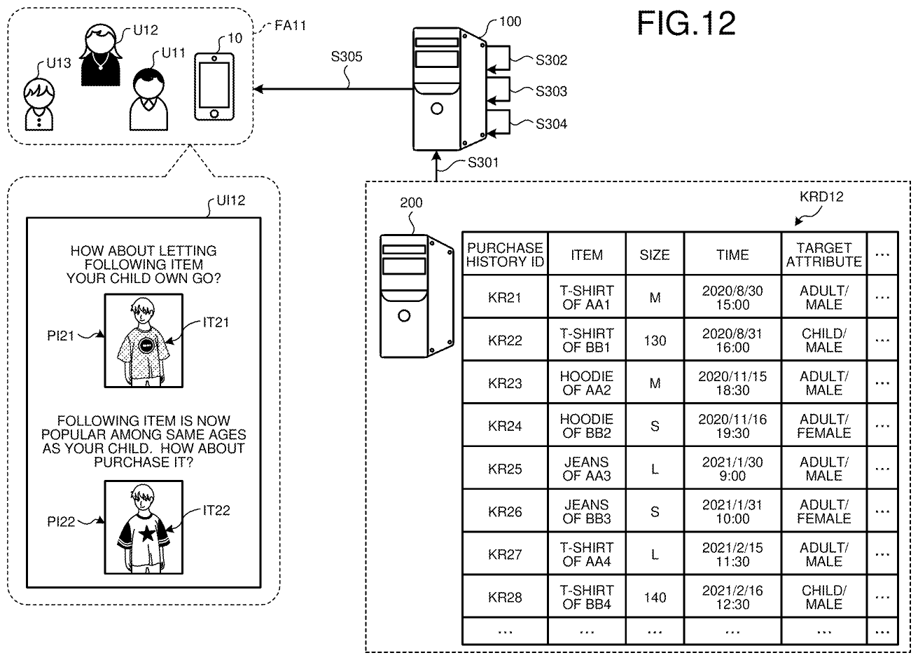

In FIG. 12, it is assumed that a proposal is given to the user U1 via the terminal apparatus 10, but explanation will be given based on the assumption that the user U11 who has an account has a family FA11 consisting of a user U12 and a user U13, and the user U12 and the user U13 are also associated with the account of the user U11. In the following, explanation will be given based on the assumption that the user U12 is a spouse of the user U11 and the user U13 is a child of the user U11. Meanwhile, in the following, for convenience of explanation, a case will be described in which three users are associated with a single account, but embodiments are not limited to this example, and the number of a plurality of users is not specifically limited.

The information processing apparatus 100 acquires information on body shapes of a plurality of users (U11 to U13) that are associated with a single account (Step S301). In FIG. 12, the information processing apparatus 100 acquires purchase history information KRD12 that is information on a purchase history about a purchase that is performed by the user U11 in the predetermined electronic mall. The purchase history information KRD12 includes a purchase history of a purchase that the user U11 has performed for the user U12 and the user U13.

The information processing apparatus 100 estimates body shape changes of the users U11 to U13 from changes of sizes of purchased products based on the purchase history information KRD12, and acquires information on the estimated body shape changes. As explanation of a specific process, the identification unit 134 identifies a user for whom the body shape change is to be determined among the users U11 to U13 based on an attribute of a purchased product included in the purchase history information KRD12 (Step S302). For example, only the user U12 among the users U11 to U13 is a woman, and therefore, if a product for female is purchased, the identification unit 134 identifies the user U12 as a determination target. Further, for example, only the user U13 is a child among the users U11 to U13, and therefore, if a product for a child is purchased, the identification unit 134 identifies the user U13 as a determination target.

The identification unit 134 identifies, from the purchase history information KRD12, a purchased product corresponding to the attribute of the user who is identified as a target of determination of the body shape change (Step S303). For example, if the user who is identified as a target of determination of the body shape change is the user U13, the identification unit 134 identifies a product for a child from the purchase history information KRD12.

The determination unit 133 determines whether the change of the body shape of the identified user is equal to or larger than the predetermined threshold based on the information on the body shape of the user identified by the identification unit 134 (Step S304). For example, if a product for a child is purchased, the determination unit 133 determines the body shape change of the user U13 based on comparison between information on the size of the product and information on a size of a past purchased product that is estimated as having been purchased for the user U13.

As a specific example, the identification unit 134 identifies purchased products identified by purchase history IDs of “KR22” and “KR28”, which are products for a child, from the purchase history information KRD12. Further, the estimation unit 132 estimates that the purchased products identified by the purchase history ID of “KR22” and “KR28” indicate products that are purchased for the user U13. Furthermore, the determination unit 133 compares the information on the sizes of the purchased product identified by the purchase history ID of “KR22” and the purchased product identified by the purchase history ID of “KR28”, and determines whether the change of the body shape of the user U13 is equal to or larger than the predetermined threshold. In FIG. 12, the size of the purchased product of the user U13 is changed from “130” to “140”, and therefore, the determination unit 133 determines that the body shape of the user U13 is increased in accordance with the change of the size from “130” to “140”.

The providing unit 135 provides information for proposing letting go of the personal property that is determined as not fitting the body shape of the user U13 and proposing purchase of a product that is estimated as fitting the current body shape of the user U13 based on the determination result obtained by the determination unit 133 (Step S305).

A screen UI12 is one example a UI screen for proposing letting go of a personal property that does not fit the body shape of the user U13 and proposing purchase of a replacement. The screen UI12 includes images PI21 and PI22. The image PI21 is an image of an item IT21 that is a personal property of the user U13 for which letting go is proposed. The image PI22 is an image of an item IT22 which is a substitute for the item IT 21 and for which a purchase is proposed. The item IT22 is an item that is available for purchase in the predetermined electronic mall in which the item IT21 has been purchased, for example.

Meanwhile, in the modification as described above, for convenience of explanation, the case has been described in which the family FA11 of the user U11 has a single child, but there may be a case in which a family has a plurality of children. In this case, the identification unit 134 may identify a target user for whom the body shape change is to be determined, based on, for example, information that is received in advance from the user U11 (for example, registration). For example, the user U11 may associate the purchased product included in the purchase history and a target user of the purchased product in advance, and the identification unit 134 may identify a target user for whom the body shape change is to be determined based on the association. Meanwhile, the association need not always be determined by the user U11, but may be determined in any method.

Meanwhile, in the modification as described above, the plurality of users may be associated with the single account based on the information that is received from the user U11, but embodiments are not limited to this example. For example, the estimation unit 132 may estimate the family structure of the user U11 based on the information on the purchased product included in the purchase history information KRD12, estimate user attributes of the plurality of estimated users, and associate the plurality of estimated users. Specifically, the estimation unit 132, if the user U11 has purchased three products with different target attributes, estimates that the family of the user U11 consists of three persons, estimate user attributes of the estimated three persons based on the respective target attributes, and associate the estimated three users and the three products with one another.

### 8. Effects

As described above, the information processing apparatus 100 according to one embodiment includes the acquisition unit 131, the determination unit 133, and the providing unit 135. The acquisition unit 131 acquires information on a body shape of a user. The determination unit 133 determines whether a change of the body shape is equal to or larger than a predetermined threshold based on the information on the body shape of the user acquired by the acquisition unit 131. The providing unit 135, when the determination unit 133 determines that the change of the body shape is equal to or larger than the predetermined threshold, provides information for proposing purchase of a substitute of a personal property of the user that does not fit the body shape of the user due to the change.

With this configuration, the information processing apparatus 100 according to one embodiment is able to provide, as a pair, a proposal for letting go and a proposal for purchase of a replacement, so that it is possible to further promote improvement in services related to purchase of a replacement for the personal property based on a body shape change of the user.

Furthermore, the providing unit 135 provides information for proposing purchase of a substitute based on information on the personal property that is identified based on a purchase history of the user provided by a server that manages a predetermined electronic mall.

With this configuration, the information processing apparatus 100 according to one embodiment is able to manage the information on the personal property of the user, so that it is possible to appropriately estimate the possibility of letting go of the personal property based on the body shape change of the user and give a proposal related to purchase of a replacement.

Moreover, the providing unit 135 provides information for proposing purchase of the substitute based on information on an item and a size of the personal property.

With this configuration, the information processing apparatus 100 according to one embodiment is able to manage, as the information on the personal property of the user, information on the item and the size of the personal property, so that it is possible to appropriately estimate the possibility of letting go of the personal property based on the body shape change of the user and give a proposal related to purchase of a replacement.

Furthermore, the providing unit 135 provides information for proposing exchange to electronic points that are given by letting the personal property go, as the information for proposing letting go of the personal property.

With this configuration, the information processing apparatus 100 according to one embodiment allows earning of electronic points in exchange for the personal property that does not fit the body shape, so that it is possible to promote improvement in motivation for a purchase of a replacement.

Moreover, the providing unit 135 provides, as the information for proposing letting go of the personal property, information for proposing putting the personal property up for auctions.

With this configuration, the information processing apparatus 100 according to one embodiment allows selling of the personal property that does not fit the body shape and earning of cash, so that it is possible to promote improvement in motivation for a purchase of a replacement.

Furthermore, the determination unit 133 determines whether the change of the body shape of the user is equal to or larger than the predetermined threshold based on a measurement history of measurement that is performed via a body shape measurement means capable of measuring the body shape of the user.

With this configuration, the information processing apparatus 100 according to one embodiment is able to measure and quantify the body shape of the user, so that it is possible to promote improvement in services related to purchase of a replacement for the personal property based on the body shape change of the user.

Moreover, the determination unit 133 determines whether the change of the body shape of the user is equal to or larger than the predetermined threshold based on information on a body shape change of the user that is estimated based on a change in a purchase history of the user.

With this configuration, the information processing apparatus 100 according to one embodiment is able to estimate the body shape change based on the purchase history of the user, so that it is possible to promote improvement in services related to purchase of a replacement for the personal property based on the body shape change of the user.

Furthermore, the determination unit 133 determines whether the change of the body shape of the user is equal to or larger than the predetermined threshold based on information on the body shape change of the user that is estimated based on a change based on an attribute of the user.

With this configuration, the information processing apparatus 100 according to one embodiment is able to estimate the body shape change from the user attribute, so that it is possible to promote improvement in services related to purchase of a replacement for the personal property based on the body shape change of the user.

Moreover, the acquisition unit 131 acquires information on body shapes of a plurality of users associated with a single account. Furthermore, the information processing apparatus 100 according to one embodiment further includes the identification unit 134 that identifies a single user to be subjected to determination by the determination unit 133 among the plurality of users based on an attribute of a purchased product included in a purchase history associated with the single account. Moreover, the determination unit 133 determines, based on a body shape of the single user identified by the identification unit 134, whether a change of the body shape of the single user is equal to or larger than a predetermined threshold. Furthermore, the providing unit 135 provides information for proposing purchase of a substitute of a personal property of the single user that does not fit the body shape of the single user due to the change, based on a determination result obtained by the determination unit 133.

With this configuration, the information processing apparatus 100 according to one embodiment is able to determine a body shape change of each of the users without keeping accounts of all of the users, so that it is possible to promote improvement in services related to purchase of a replacement of the personal property for each of the users included in the account.

Moreover, the identification unit 134 identifies a single user to be subjected to determination based on comparison between attributes of a plurality of users estimated based on the purchase history associated with the single account and an attribute of the purchased product.

With this configuration, the information processing apparatus 100 according to one embodiment is able to improve accuracy for identifying the user for whom the body shape change is to be determined, so that it is possible to promote improvement in services related to purchase of a replacement for the personal property for each of the users included in the account.

### 9. Hardware Configuration

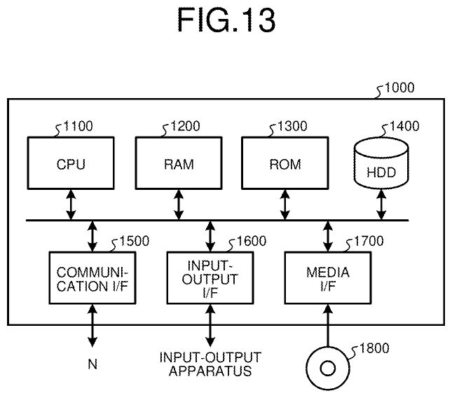

The terminal apparatus 10, the information processing apparatus 100, and the management server 200 according to one embodiment as described above are implemented by, for example, a computer 1000 as illustrated in FIG. 13. FIG. 13 is a hardware configuration diagram illustrating an example of the computer that implements the functions of the terminal apparatus 10, the information processing apparatus 100, and the management server 200. The computer 1000 includes a CPU 1100, a RAM 1200, a ROM 1300, an HDD 1400, a communication interface (I/F) 1500, an input-output interface (I/F) 1600, and a media interface (I/F) 1700.

The CPU 1100 operates based on a program that is stored in the ROM 1300 or the HDD 1400 and controls each of the units. The ROM 1300 stores therein a boot program that is executed by the CPU 1100 when the computer 1000 is activated, a program that is dependent on hardware of the computer 1000, or the like.

The HDD 1400 stores therein the program that is executed by the CPU 1100, data that is used by the program, and the like. The communication interface 1500 receives data from a different apparatus via a predetermined communication network, sends the data to the CPU 1100, and transmits data generated by the CPU 1100 to a different apparatus via the predetermined communication network.

The CPU 1100 controls an output apparatus, such as a display or a printer, and an input apparatus, such as a keyboard or a mouse, via the input-output interface 1600. The CPU 1100 acquires data from the input apparatus via the input-output interface 1600. Further, the CPU 1100 outputs generated data to the output apparatus via the input-output interface 1600.

The media interface 1700 reads the program or the data that is stored in a recording medium 1800, and provides the program or the data to the CPU 1100 via the RAM 1200. The CPU 1100 loads the program from the recording medium 1800 onto the RAM 1200 via the media interface 1700, and executes the loaded program. The recording medium 1800 is, for example, an optical recording medium, such as a Digital Versatile Disc (DVD) or a phase change rewritable Disk (PD), a magneto optical recording medium, such as a Magneto-Optical disk (MO), a tape medium, a magnetic recording medium, a semiconductor memory, or the like.

For example, when the computer 1000 functions as the terminal apparatus 10, the information processing apparatus 100, and the management server 200 according to one embodiment, the CPU 1100 of the computer 1000 executes programs that are loaded on the RAM 1200 and implements the functions of the control units 14, 130, and 230. The CPU 1100 of the computer 1000 reads the programs from the recording medium 1800 and executes the programs; however, as another example, it may be possible to acquire the programs from a different apparatus via a predetermined communication network.

### 10. Others

Of the processes described in the embodiments, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in each of the drawings are not limited to the information illustrated in the drawings.

Furthermore, the components illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

Moreover, the embodiments as described above may be combined appropriately as long as no contradiction is derived in the processing contents.

While some embodiments of the present application have been described in detail above based on the drawings, the embodiments are described by way of example, and the present invention may be embodied in various other forms with various changes or modifications based on knowledge of a person skilled in the art, in addition to the embodiments described in “Description of Embodiments”.

In addition, “a section, a module, or a unit” described above may be replaced with “a means” or “a circuit”. For example, the acquisition unit may be replaced with an acquisition means or an acquisition circuit.

### REFERENCE SIGNS LIST

1 information processing system
10 terminal apparatus
11 communication unit
12 input unit
13 output unit
14 control unit
100 information processing apparatus
110 communication unit
120 storage unit
121 personal property information storage unit
122 user attribute storage unit
123 measurement history storage unit
130 control unit
131 acquisition unit
132 estimation unit
133 determination unit
134 identification unit
135 providing unit
141 reception unit
142 transmission unit
200 management server
210 communication unit
220 storage unit
221 purchase history storage unit
222 product information storage unit
230 control unit
231 acquisition unit
232 providing unit
N network

1. An information processing apparatus including a processor configured to:
acquire information on a body shape of a user;
determine whether a change of the body shape is equal to or larger than a predetermined threshold based on the acquired information; and
in response to determining that the change of the body shape is equal to or larger than the predetermined threshold, provide the user with information for proposing purchase of a substitute of a personal property of the user, the personal property not fitting the body shape of the user due to the change.

2. The information processing apparatus according to claim 1, wherein the processor is further configured to provide the user with the information for proposing purchase of the substitute based on information on the personal property that is identified based on a purchase history of the user provided by a server that manages a predetermined electronic mall.

3. The information processing apparatus according to claim 2, wherein the processor is further configured to provide the user with the information for proposing purchase of the substitute based on information on an item and a size of the personal property.

4. The information processing apparatus according to claim 1, wherein the processor is further configured to provide the user with information for proposing exchange of the personal property for electronic points to propose release of the personal property.

5. The information processing apparatus according to claim 1, wherein the processor is configured to provide the user with information for proposing listing of the personal property for auction to propose release of the personal property for auctions.

6. The information processing apparatus according to claim 1, wherein the processor is further configured to determine whether the change of the body shape of the user is equal to or larger than the predetermined threshold based on a measurement history of the body shape of the user.

7. The information processing apparatus according to claim 1, wherein the processor is further configured to determine whether the change of the body shape of the user is equal to or larger than the predetermined threshold based on information on a body shape change of the user that is estimated based on a change in a purchase history of the user.

8. The information processing apparatus according to claim 7, wherein the processor is further configured to determine whether the change of the body shape of the user is equal to or larger than the predetermined threshold based on information on the body shape change of the user that is estimated based on a change based on an attribute of the user.

9. The information processing apparatus according to claim 1, wherein the processor is further configured to:
acquire information on body shapes of a plurality of users associated with a single account;
identify a single user to be subjected to determination among the plurality of users based on an attribute of a purchased product included in a purchase history associated with the single account;
based on a body shape of the identified single user, determine whether a change of the body shape of the single user is equal to or larger than a predetermined threshold; and
based on determining whether the change of the body shape of the single user is equal to or larger than the predetermined threshold, provide the single user with information for proposing purchase of a substitute of a personal property of the single user, the personal property not fitting the body shape of the single user due to the change.

10. The information processing apparatus according to claim 9, the processor is further configured to identify the single user to be subjected to determination based on comparison between attributes of the plurality of users estimated based on the purchase history associated with the single account and an attribute of the purchased product.

11. An information processing method implemented by a computer, the information processing method including:
acquiring information on a body shape of a user;
determining whether a change of the body shape is equal to or larger than a predetermined threshold based on the acquired information; and
in response to determining that the change of the body shape is equal to or larger than the predetermined threshold, providing the user with information for proposing purchase of a substitute of a personal property of the user, the personal property not fitting the body shape of the user due to the change.

12. A non-transitory tangible machine-readable medium having an information processing program that, when executed by the computer, causes the computer to execute:
acquire information on a body shape of a user;
determine whether a change of the body shape is equal to or larger than a predetermined threshold based on the acquired information; and
in response to determining that the change of the body shape is equal to or larger than the predetermined threshold, provide the user with information for proposing purchase of a substitute of a personal property of the user, the personal property not fitting the body shape of the user due to the change.
